(19) United States
(12) Patent Application Publication
(10) Pub. No.: US 2025/0224760 A1
(43) Pub. Date: Jul. 10, 2025

(54) CLOCK ARCHITECTURE AND PROCESSING ASSEMBLY

(71) Applicant: SUZHOU METABRAIN INTELLIGENT TECHNOLOGY CO., LTD., Suzhou, Jiangsu (CN)

(72) Inventor: Youjyun JHANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/850,553

(22) PCT Filed: May 10, 2023
(86) PCT No.: PCT/CN2023/093323

§ 371 Date: Sep. 24, 2024

(30) Foreign Application Priority Data
Nov. 30, 2022 (CN) 202211518351.2

(51) Int. Cl. G06F 1/08

(52) U.S. Cl. CPC G06F 1/08

(57) ABSTRACT

A clock architecture, including one or more clock module layers; each clock module layer including one or more clock modules, each clock module including a local clock generator, a selection switch circuit and a plurality of clock buffer circuits; wherein the local clock generator is configured to generate an independent local clock signal; a first input terminal of the selection switch circuit receives the local clock signal, a second input terminal of the selection switch circuit receives an external clock signal, a plurality of output terminals of the selection switch circuit are respectively connected to input terminals of the plurality of clock buffer circuits, and an enable terminal of the selection switch circuit is configured to receive an enable signal; and the selection switch circuit is configured to enable, all the output terminals to output the local clock signal or enable all the output terminals to output the external clock signal, according to the enable signal.

### CROSS-REFERENCE TO RELATED APPLICATION

The present application is a National Stage Application of PCT International Application No.: PCT/CN2023/093323 filed on May 10, 2023, which claims priority to Chinese Patent Application 202211518351.2, filed in the China National Intellectual Property Administration on Nov. 30, 2022, the disclosure of which is incorporated herein by reference in its entirety.

### TECHNICAL FIELD

Embodiments of the present disclosure relate to the field of clock control, and in particular, to a clock architecture and a processing assembly.

### BACKGROUND

Currently, in order to increase the computing speed of a system, high-speed computing assemblies emerge as required, and each computing module in the high-speed computing assembly may achieve independent computing and execute/run a task, thereby increasing the completion speed of a computing task. However, in the high-speed computing assembly, communication between different modules has a certain frequency synchronization requirement, and when the phase deviation between communication frequencies is too large, a correctable error and/or an uncorrectable error may occur in a communication process.

Thus, the setting of communication frequencies in the high-speed computing assembly is relatively harsh, and once a frequency topology structure is fixed, the structure is no longer expanded; and a topology structure and computing power of computing modules of the high-speed computing assembly are also limited, such that the frequency may not be flexibly adjusted in the high-speed computing assembly, and the computing power of the entire computing assembly is in an undesirable state.

Aiming at the described technical problems existing in the related art, no effective solution has been proposed by a person skilled in the art.

### SUMMARY

In view of this, an object of embodiments of the present disclosure is to provide a clock architecture and a processing assembly which are more flexible and may provide higher computing power support. The solution is as follows:
a clock architecture, the clock architecture including one or more clock module layers; each clock module layer includes one or more clock modules, each clock module including a local clock generator, a selection switch circuit and a plurality of clock buffer circuits; wherein
the local clock generator is configured to generate an independent local clock signal;
a first input terminal of the selection switch circuit receives the local clock signal, a second input terminal of the selection switch circuit receives an external clock signal, a plurality of output terminals of the selection switch circuit are respectively connected to input terminals of the plurality of clock buffer circuits, and an enable terminal of the selection switch circuit is configured to receive an enable signal; and
the selection switch circuit is configured to enable, all the output terminals to output the local clock signal or enable all the output terminals to output the external clock signal, according to the enable signal.

Optionally, the external clock signal of the clock module in the highest clock module layer is provided by a host server.

Optionally, an output terminal of each clock buffer circuit is connected to a next-stage module one by one, and the next-stage module includes a non-clock module and/or the clock module at a next clock module layer.

Optionally, when the next-stage module is the clock module at the next clock module layer, the output terminal of the corresponding clock buffer circuit is connected to the second input terminal of the clock module at the next clock module layer.

Optionally, each clock module further includes:
a Baseboard Management Controller (BMC) circuit, configured to be connected to the enable terminal of the selection switch circuit and generate the enable signal.

Optionally, the clock architecture further includes a hub;
and physical layer interfaces of all the BMC circuits and network ports of the host server are respectively connected to interfaces of the hub.

Optionally, the non-clock module includes a computing module and/or a communication module and/or a storage module, and each computing module is respectively connected to one output terminal of the clock buffer circuit.

Optionally, the computing module includes an Field Programmable Gate Array (FPGA) circuit, and/or a Complex Programmable Logic Device (CPLD) circuit, and/or a Graphics Processing Unit (GPU) circuit;
the computing module further includes a storage circuit, the storage circuit being connected to the FPGA circuit or the CPLD circuit or the GPU circuit.

Optionally, the communication module includes: a communication unit and/or a communication card slot, and a clock terminal of the communication module is independently connected to one output terminal of the clock buffer circuit.

Optionally, when the next-stage module is the clock module at the next clock module layer, the output terminal of the corresponding clock buffer circuit is connected to the second input terminal of the clock module at the next clock module layer via one communication card slot.

Optionally, a maximum allowable number of layers of clock module layers in the clock architecture is determined by the maximum clock jitter limit.

Optionally, the process that the maximum allowable number of layers of clock module layers is determined by the maximum clock jitter limit, includes:
a topological relationship of a current clock architecture is acquired;
a clock link with the longest communication path in the topological relationship is determined;
a jitter value of the clock link is calculated according to a jitter value of each element of the current clock architecture; and
the maximum allowable number of layers in the clock architecture is determined according to the jitter value and the maximum clock jitter limit.

Optionally, the process that the maximum allowable number of layers in the clock architecture is determined according to the jitter value and the maximum clock jitter limit, includes:
the magnitude of the jitter value is compared with that of the maximum clock jitter limit;
the number of layers of clock module layers in the current clock architecture is adjusted, and return to execute the operation that the topological relationship of the current clock architecture is acquired; and
when the jitter value corresponding to N clock module layers exceeds the maximum clock jitter limit and the jitter value corresponding to N−1 clock module layers does not exceed the maximum clock jitter limit, it is determined that the maximum allowable number of layers in the clock architecture is N−1; where N is an integer not less than 1.

Optionally, the process that the jitter value of the clock link is calculated according to the jitter value of each element of the current clock architecture, includes:
square root calculation is performed on a sum of squares of the jitter values of various elements on the clock link to obtain the jitter value of the clock link.

Optionally, a General Purpose Input/Output (GPIO) terminal of the BMC circuit is connected to the enable terminal of the selection switch circuit, and the GPIO terminal is configured to send the enable signal to the enable terminal.

Optionally, the process of enabling, all the output terminals to output the local clock signal or enabling all the output terminals to output the external clock signal, according to the enable signal, includes:
all the output terminals are enabled to output the local clock signal simultaneously or all the output terminals are enabled to output the external clock signal simultaneously according to a relationship between a level of the enable signal and configuration.

Optionally, the storage circuit includes a memory bank and a storage hard disk.

Optionally, the maximum clock jitter limit is determined according to a communication protocol used.

Correspondingly, some embodiments of the present disclosure further disclose a processing assembly, including:
a clock architecture, the clock architecture including one or more clock module layers each clock module layer including one or more clock modules, each clock module including a local clock generator, a selection switch circuit and a plurality of clock buffer circuits; wherein
the local clock generator is configured to generate an independent local clock signal;
a first input terminal of the selection switch circuit receives the local clock signal, a second input terminal of the selection switch circuit receives an external clock signal, a plurality of output terminals of the selection switch circuit are respectively connected to input terminals of the plurality of clock buffer circuits, and an enable terminal of the selection switch circuit is configured to receive an enable signal; and
the selection switch circuit is configured to enable, all the output terminals to output the local clock or enable all the output terminals to output the external clock signal, according to the enable signal; and
a host server, providing an external clock signal for the highest clock module layer in the clock architecture;
wherein each clock signal terminal is respectively connected to a plurality of non-clock modules of the output terminal of the clock buffer circuit in the clock architecture.

Optionally, the processing assembly is a high-speed computing module, and clocks of all units in the high-speed computing module are correspondingly provided by the clock architecture.

Embodiments of the present disclosure disclose a clock architecture; the selection switch circuit in each clock module may select the local clock signal or the external clock signal as an output clock, such that regulation and control of clock in a processing assembly using the clock architecture, such as a high-speed computing assembly, is more flexible; and the characteristics of the clock architecture being scalable and the clock being selectable provide a reliable basis for improving the accurate operation of the processing assembly.

### BRIEF DESCRIPTION OF THE DRAWINGS

In order to describe the technical solutions in embodiments of the present disclosure or in the related art more clearly, hereinafter, accompanying drawings requiring to be used in the embodiments or the related art will be introduced briefly. Apparently, the accompanying drawings in the following description merely relate to embodiments of the present disclosure, and for a person of ordinary skill in the art, other accompanying drawings may also be obtained according to the provided accompanying drawings without involving any inventive effort.

FIG. 1 is a structural distribution diagram of a clock module in embodiments of the present disclosure;

FIG. 2 is a structural distribution diagram of a clock architecture in embodiments of the present disclosure;

FIG. 3a is a structural distribution diagram of a common clock architecture according to embodiments of the present disclosure;

FIG. 3b is a structural distribution diagram of a separate clock architecture according to embodiments of the present disclosure;

FIG. 4 is a flowchart of operations for determining the maximum allowable number of layers in a clock architecture according to embodiments of the present disclosure; and

FIG. 5 is a structural distribution diagram of an optional clock architecture in embodiments of the present disclosure;

### DETAILED DESCRIPTION OF THE EMBODIMENTS

Hereinafter, the technical solutions in embodiments of the present disclosure will be described clearly and completely with reference to the accompanying drawings of the embodiments of the present disclosure. Obviously, the embodiments as described are only some of the embodiments of the present disclosure, and are not all of the embodiments of the present disclosure. All other embodiments obtained by a person of ordinary skill in the art on the basis of the embodiments of the present disclosure without involving any inventive effort shall all fall within the scope of protection of the embodiments of the present disclosure.

The setting of communication frequencies in a high-speed computing assembly is relatively harsh, and once a frequency topology structure is fixed, the structure is no longer expanded; and a topology structure and computing power of computing modules of the high-speed computing assembly are also limited, such that the frequency may not be flexibly adjusted in the high-speed computing assembly, and the computing power of the entire computing assembly is in an undesirable state.

Embodiments of the present disclosure disclose a clock architecture; a selection switch circuit in each clock module may select a local clock signal or an external clock signal as an output clock, such that regulation and control of clock in a processing assembly using the clock architecture, such as a high-speed computing assembly, is more flexible; and the characteristics of the clock architecture being scalable and the clock being selectable provide a reliable basis for improving the accurate operation of the processing assembly.

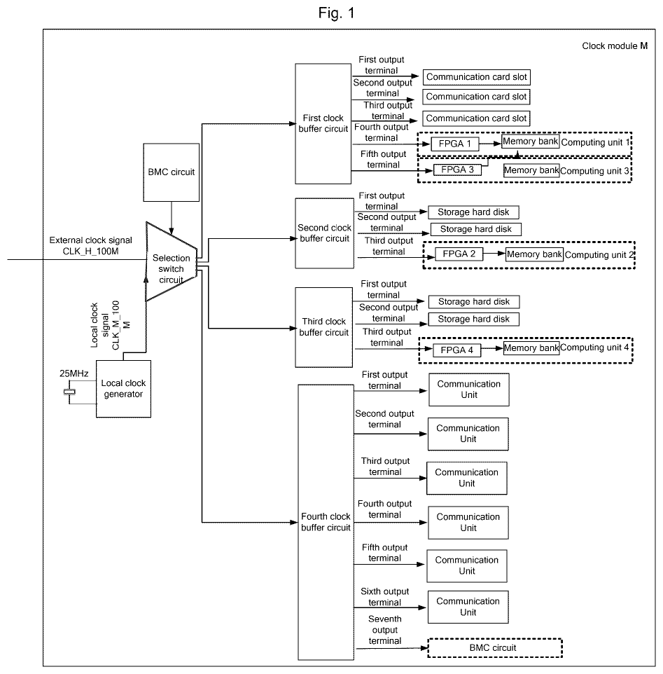

Embodiments of the present disclosure disclose a clock architecture. The clock architecture includes one or more clock module layers; wherein each clock module layer includes one or more clock modules M. Refer to FIG. 1, each clock module M includes a local clock generator clk gen, a selection switch circuit MUX, and a plurality of clock buffer circuits clk buffer, wherein
the local clock generator clk gen is configured to generate an independent local clock signal clk_m;
a first input terminal of the selection switch circuit MUX receives the local clock signal clk_m, a second input terminal of the selection switch circuit receives an external clock signal clk_h, a plurality of output terminals of the selection switch circuit MUX are respectively connected to input terminals of the plurality of clock buffer circuits clk buffer, and an enable terminal of the selection switch circuit MUX is configured to receive an enable signal; and
the selection switch circuit MUX is configured to enable, all the output terminals to output the local clock signal clk_m or enable all the output terminals to output the external clock signal clk_h, according to the enable signal.

It may be understood that the external clock signal clk_h of the clock module M in the highest clock module layer is provided by a host server.

It may be understood that an output terminal of each clock buffer circuit clk buffer is connected to a next-stage module one by one, and the next-stage module includes a non-clock module and/or a clock module M at a next clock module layer. Optionally, when the next-stage module is the clock module M at the next clock module layer, the output terminal of the corresponding clock buffer circuit clk buffer is connected to the second input terminal of the clock module M at the next clock module layer.

Optionally, the clock module M at each layer further includes: a Baseboard Management Controller (BMC) circuit, configured to be connected to the enable terminal of the selection switch circuit MUX and generate the enable signal. It may be understood that usually, a GPIO terminal of the BMC circuit is connected to the enable terminal SEL pin of the MUX, and sends the enable signal to the enable terminal SEL pin.

It may be understood that the two input terminals of the selection switch circuit MUX receive two different clocks: the local clock signal clk_m and the external clock signal clk_h; according to the characteristics of the selection switch circuit MUX, all the output terminals of the selection switch circuit MUX output the same output clock; and according to a relationship between a level of the enable signal and configuration, all the output terminals of the selection switch circuit MUX may simultaneously output the local clock signal clk_m, or all the output terminals of the selection switch circuit MUX may simultaneously output the external clock signal clk_h. By selecting the output of the selection switch circuit MUX in the current clock module M, a corresponding clock is provided for the next-stage module in the current clock module M, so as to ensure that the next-stage module operates according to the clock.

It may be understood that the non-clock module includes a computing module and/or a communication module and/or a storage module, and each computing module is respectively connected to one output terminal of the clock buffer circuit clk buffer.

It may be understood that detailed setting of the non-clock module may be adjusted according to the actual type of a processing assembly to which the clock architecture is applied. Hereinafter, description is made in detail by taking the processing assembly being a high-speed computing assembly as an example:

In some optional embodiments, the computing module includes an Field-Programmable Gate Array (FPGA) circuit, and/or a Complex Programmable Logic Device (CPLD) circuit, and/or a Graphics Processing Unit (GPU) circuit; the computing module further includes a storage circuit, the storage circuit being connected to the FPGA circuit or the CPLD circuit or the GPU circuit. It may be understood that generally, the storage circuit and the FPGA circuit may form one computing unit, i.e. a Computing Module, and a plurality of computing units may form one high-speed computing assembly; clocks of all the units in the high-speed computing assembly are correspondingly provided by the clock architecture in the present embodiment. As the clock supply of the clock architecture in the present embodiment is flexible and the architecture is scalable, clock support may be provided for computing modules with higher computing power. The actual type of the computing module depends on the internal structure of the high-speed computing module to be served by the clock architecture.

Optionally, the storage circuit includes a memory bank and a storage hard disk, wherein the memory bank may be selected as Dual Inline Memory Modules (DIMMs), and the storage hard disk may be selected from an Solid State Disk (SSD) or other forms of storage hard disks. Similarly, the actual type of storage circuit depends on the internal structure of the high-speed computing module to be served by the clock architecture.

Optionally, the communication module includes: a communication unit and/or a communication card slot, and a clock terminal of the communication module is independently connected to one output terminal of the clock buffer circuit clk buffer. It may be understood that the communication unit and the communication card slot may be determined according to a communication protocol; a PCIe protocol (peripheral component interconnect express, a high-speed serial computer expansion bus standard) is usually selected. Correspondingly, the communication unit includes but is not limited to a PCIe switch, and the communication card slot includes a PCIe slot.

Taking the single-layer clock module M shown in FIG. 1 as an example, the clock module M includes four clock buffer circuits: a first clock buffer circuit clk buffer 1, a second clock buffer circuit clk buffer 2, a third clock buffer circuit clk buffer 3, and a fourth clock buffer circuit clk buffer 4; output terminals of all the clock buffer circuits clk buffer provide the same clock, and the number of output terminals on each clock buffer circuit clk buffer and the number of channels provided by each output terminal may be determined according to the internal structure of the high-speed computing module to be served by the clock architecture.

Optionally, in FIG. 1, the first clock buffer circuit clk buffer 1 provides five output terminals; wherein a first output terminal clk_<0:3> is connected to a communication card slot PCIe slot*4, and provides a clock for a host; a second output terminal clk<4:7> is connected to a communication card slot PCIe slot*4, and provides a clock for scale-up; a third output terminal clk<8:11> is connected to a communication card slot PCIe slot*4, and provides a clock for scale-out; a fourth output terminal clk_<12:15> is connected to a computing module FPGA 1, and the FPGA 1 is further connected to a memory bank DIMM, and the two form a computing unit, i.e. Computing Module 1; and a fifth output terminal clk_<16:19> is connected to a computing module FPGA 3, and the FPGA 3 is also connected to another memory bank DIMM, and the two form a computing unit, i.e. Computing Module 3.

Similarly, in FIG. 1, the second clock buffer circuit clk buffer 2 provides three output terminals; wherein a first output terminal clk_<0:7> is connected to an 8-channel storage hard disk of an NVME protocol, i.e. NVME SSD*8 (denoted as SW #1); a second output terminal clk<8:15>is connected to another 8-channel storage hard disk of an NVME protocol, i.e. NVME SSD*8 (denoted as SW #2); and a third output terminal clk_<16:19> is connected to a computing module FPGA 2, and the FPGA 2 is also connected to a memory bank DIMM, and the two form a computing unit, i.e. Computing Module 2.

Similarly, in FIG. 1, the third clock buffer circuit clk buffer 3 provides three output terminals; wherein a first output terminal clk_<0:7> is connected to an 8-channel storage hard disk of an NVME protocol, i.e. NVME SSD*8 (denoted as SW #3); a second output terminal clk_<8:15> is connected to another 8-channel storage hard disk of an NVME protocol, i.e. NVME SSD*8 (denoted as SW #4); and a third output terminal clk_<16:19> is connected to a computing module FPGA 4, and the FPGA 4 is also connected to a memory bank DIMM, and the two form a computing unit, i.e. Computing Module 4.

Similarly, in FIG. 1, the fourth clock buffer circuit clk buffer 4 provides seven output terminals; wherein a first output terminal to a sixth output terminal 100M<0>, 100M<1>, 100M<2>, 100M<3>, 100M<4>, 100M<5> are respectively connected to communication units: PCIe switch #1-PCIe switch #5, and a seventh output terminal 100M<6> is connected to a BMC circuit; the BMC circuit herein refers to a BMC circuit which is configured to output the enable signal in the current clock module M. Hence, the output terminal of the clock buffer circuit clk buffer may also be connected to the BMC circuit, thereby providing clock support for the BMC circuit.

It may be understood that the next-stage module of each clock module M is in an actual form of a non-clock module, which may be determined according to the internal structure of the high-speed computing module to be served by the clock architecture; and when the next-stage module of the clock module M is a clock module M at a next clock module layer, adjacent clock modules M are connected in series. Optionally, each clock module M has an independent local clock signal clk_m generated by an internal local clock generator clk gen and an external clock signal clk_h; the external clock signal clk_h of the clock module M in the highest clock module layer is provided by the host server, and the external clock signals clk_h of the clock modules M of other clock module layers are provided by the clock modules M of previous layers; one output terminal of the selection switch circuit MUX in the clock module M of the previous layer is connected to an input terminal of one clock buffer circuit clk buffer, and an output terminal of the clock buffer circuit clk buffer is connected to a second input terminal of the clock module M of another clock module layer, and sends the external clock signal clk_h to the clock module M of the another clock module layer.

It may be understood that when the next-stage module is the clock module M at the next clock module layer, the output terminal of the corresponding clock buffer circuit clk buffer is connected to the second input terminal of the clock module M at the next clock module layer via one communication card slot.

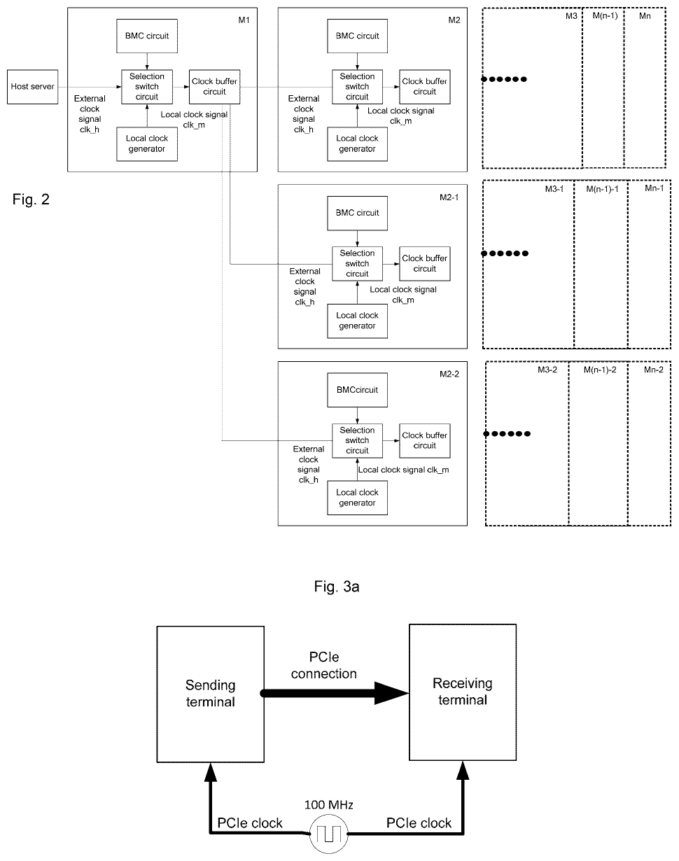

As shown in FIG. 2, FIG. 2 is an example of an optional clock architecture. In the clock architecture, the content that the next-stage module is a non-clock module is ignored, and this clock architecture is only directed to a connection structure of the clock modules M in multiple clock module layers; wherein M1 is a clock module at a highest clock module layer, an external clock signal thereof is provided by the host server, and M1 provides the external clock signal for clock modules M2, M2-1, M2-2 and M2-3 at a second clock module layer respectively via a plurality of communication card slots PCIe slots; and the clock modules at the second clock module layer provide the external clock signal for next-layer clock modules respectively connected thereto. For each clock module, there are two optional clocks, i.e. the external clock signal clk_h and the local clock signal clk_m, and inside the clock module M, from the two optional clocks, a clock may be determined as a clock of the non-clock module and a clock may be determined as an external clock signal of the clock module M at a next clock module layer via the selection switch MUX.

It may be understood that in the PCIe standard description, one PCIe channel includes two terminals for sending and receiving, and the total PCIe connection data bandwidth may be extended by adding an additional channel, and the flexibility thereof makes PCIe ubiquitous in applications such as servers, network attached storage, network switches, routers, and TV set-top boxes, etc. The strict timing computing of these applications themselves and the challenges of system design impose stringent performance requirements on PCIe frequencies. Generally, PCIe specifies a 100 MHz external reference frequency, i.e. Refclk, which has an accuracy within +300 ppm and is set to coordinate data transmission between two PCIe devices. The PCIe standard supports three ranges of frequency allocation schemes: a common frequency, a data frequency, and a separate clock architecture. All frequency schemes require a frequency precision of +300 ppm.

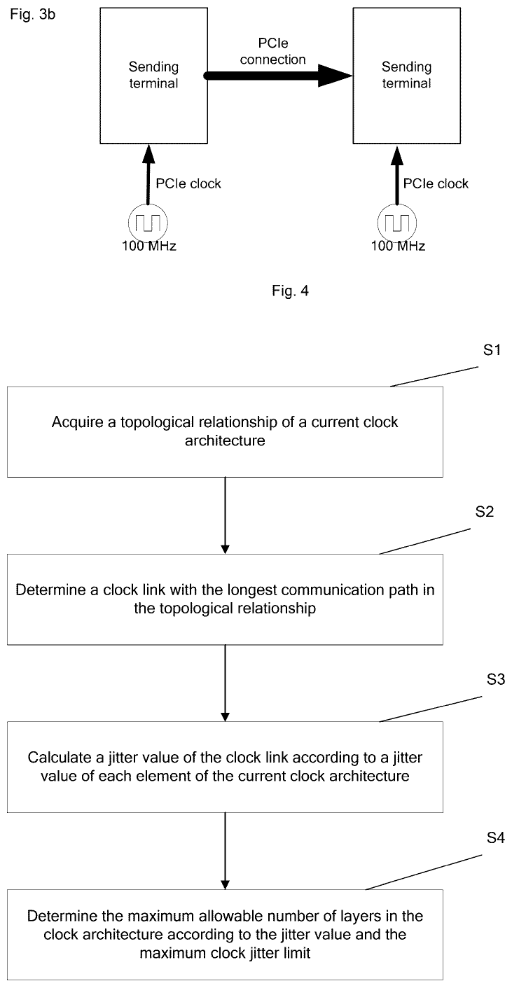

Optionally, a common clock architecture (Common Clock) is as shown in FIG. 3a, in which a single clock source is allocated to both a sending terminal (PCIe Device A) and a receiving terminal (PCIe Device B). Such a frequency manner is simple and commonly used in cost-sensitive product applications, and may support SSC (Spread Spectrum Clocking) and reduce the effect of EMI (Electro Magnetic Interference).

Optionally, a separate clock architecture (Separate Reference Clock) is as shown in FIG. 3b, in which a sending terminal (PCIe Device A) and a receiving terminal (PCIe Device B) use separate frequency sources, and do not simultaneously send frequencies to all PCIe endpoints. The frequency interval of the separate frequency source standards needs to be maintained between +600 ppm, such that each reference clock may still maintain a frequency precision of +300 ppm. Also due to independent operation of frequencies, effective jitter of a receiver becomes a root-sum square (RSS) of sender jitter and receiver phase locked loop (PLL). This separate clock architecture has no jitter limitation, but typically requires a more stringent clock jitter budget than that in the common frequency architecture. In the related art, when an overall frequency amplitude of +300 ppm is required, the limitation of frequency interval between reference blocks in the separate clock architecture greatly hinders the application of SSC.

It may be understood that PCIe connection is configured to transfer large amounts of data from a transmitter to the receiver, and ensures a high success rate of data transmission. In order to achieve this, the data transferred by the transmitter in a bit center or adjacent bits must be sampled by the receiver, and a frequency/frequency data recovery (Clock/Data Recovery block, CDR) in the receiver will generate a frequency, and the data is periodically sampled to a latch. In this process, various phase jitter sources cause a fluctuation of a sample time sequence. As the sample position deviates from an ideal position, the Bit Error rate increases, thereby causing a correctable error or an uncorrectable error when PCIe is in operation.

Correspondingly, in this embodiment, clocks in the clock architecture are optional, and not only a common clock architecture may be selected to be supported to provide clocks for the high-speed computing assembly, but also a separate clock architecture may be selected to be supported to provide clocks for the high-speed computing assembly. The clock architecture supports automatic switching between the two clock architectures, and also supports a spread spectrum frequency (SSC) and clock jitter budget control.

Optionally, a maximum allowable number of layers of clock module layers in the clock architecture is determined by the maximum clock jitter limit. Generally, the maximum clock jitter limit is determined according to a communication protocol used, and different clock jitter limits may be specified for different PCIe protocols by using a PCI sig protocol, as shown in Table 1 below:

TABLE 1
Correspondence table between PCIe protocols and maximum
clock jitter limits (Common Clock Jitter Limit)

| Data Rate | PCIe Gen | Common Clock Jitter Limit |
|---|---|---|
| 2.5G | 1 | 108 ps PK-PK |
| 5G | 2 | 3.1 ps RMS |
| 8G | 3 | 1.0 ps RMS |
| 16G | 4 | 0.5 ps RMS |

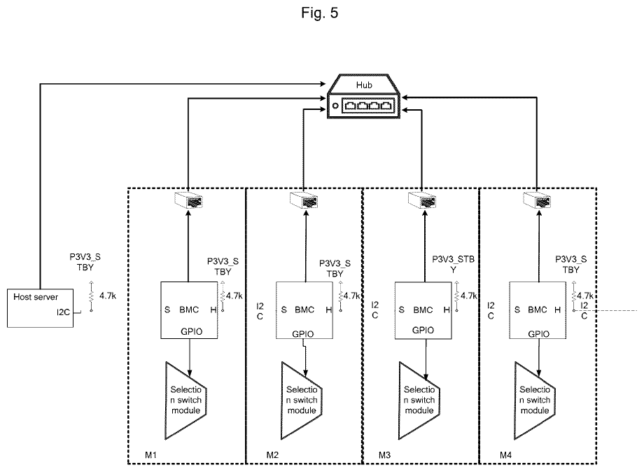

Optionally, in the clock architecture, the calculation of the clock jitter uses element jitter as a calculation parameter, and the jitter value of the clock link with the longest communication path serves as the clock jitter value of the current clock architecture. Optionally, the process that the maximum allowable number of layers of clock module layers is determined by the maximum clock jitter limit is as shown in FIG. 4 and includes:
S1: a topological relationship of a current clock architecture is acquired;
S2: a clock link with the longest communication path in the topological relationship is determined;
S3: a jitter value of the clock link is calculated according to a jitter value of each element of the current clock architecture; and
S4: the maximum allowable number of layers in the clock architecture is determined according to the jitter value and the maximum clock jitter limit.

In some optional embodiments, the process that the maximum allowable number of layers in the clock architecture is determined according to the jitter value and the maximum clock jitter limit, includes:
the magnitude of the jitter value is compared with that of the maximum clock jitter limit;
the number of layers of clock module layers in the current clock architecture is adjusted, and return to execute the operation that the topological relationship of the current clock architecture is acquired; and
when the jitter value corresponding to N clock module layers exceeds the maximum clock jitter limit and the jitter value corresponding to N−1 clock module layers does not exceed the maximum clock jitter limit, it is determined that the maximum allowable number of layers in the clock architecture is N−1; where N is an integer not less than 1.

In some optional embodiments, the process that the jitter value of the clock link is calculated according to the jitter value of each element of the current clock architecture, includes:
square root calculation is performed on a sum of squares of the jitter values of various elements on the clock link to obtain the jitter value of the clock link.

Optionally, taking FIG. 1 as an example, the model of the local clock generator clk gen may be selected as a 9SQ440 from the company IDT, and the 9SQ440 may generate a stable clock source output of 100 MHz through an external quartz crystal oscillator of 25 MHz; the model of the selection switch circuit MUX may be selected as a 9DML04 from the company IDT, and the 9DML04 has two 100 MHz clock input terminals and has four stable 100 MHz output terminals; the model of the BMC circuit may be selected as AST2600 from ASPEED company, and the model of the clock buffer circuit clk buffer may be selected as 9QXL2001BNHGI; and the BMC circuit is connected to an enable pin SEL pin of the selection switch circuit MUX via a GPIO terminal, so as to achieve the function of automatically switching an input port. Optionally, when the GPIO terminal outputs a low-level enable signal, the selection switch circuit MUX switches a clock input port to the external clock signal clk_h; and when the GPIO terminal outputs a high-level enable signal, the selection switch circuit MUX switches the clock input port to the local clock signal clk_m. The enable control logic may also be adjusted according to actual needs, which is not limited herein.

Taking FIG. 1 as an example, according to the model-selected maximum clock jitter parameter, the element jitter of the external clock signal clk_h provided by the host server is 200 fs, the element jitter of the selection switch circuit MUX is 100 fs, the element jitter of the clock buffer circuit clk buffer is 40 fs, and the clock jitter value of the current clock module M is jitter_rms=\sqrt{200²+100²+40²}=227.2.1fs, and the maximum clock jitter limit of the current clock architecture is 500 fs rms, and apparently, the clock jitter value of the current clock module M is less than the maximum clock jitter limit.

Optionally, the selected model in FIG. 1 is applied to the clock architecture in FIG. 2. Taking the number of the clock module layers n=3, that is, the clock link with the longest communication path being 3 as an example, the clock jitter value of the clock architecture in FIG. 2 is:

$$jitter\_rms = \sqrt{{200}^{2} + {100}^{2} + {40}^{2} + {100}^{2} + {40}^{2} + {100}^{2} + {40}^{2}} = 273.5 fs ;$$

the maximum clock jitter limit is still 500 fs rms, and thus the clock jitter value of three clock module layers meets the requirement of clock jitter.

Optionally, for applying the selected model in FIG. 1 to the clock architecture of FIG. 2, suppose that the element jitter of the external clock signal clk_h provided by the host server is 200 fs, the element jitter of the selection switch circuit MUX in each clock module M is 100 fs, and the element jitter of the clock buffer circuit clk buffer is 40 fs, then the clock link with the longest communication path corresponding to N clock module layers includes N clock modules M connected in series; in this case, the jitter value of the clock link is calculated as: jitter_rmx=\sqrt{200²+(100²+40²)×N}. By taking the values of N one by one and calculating the jitter value, the maximum allowable number of layers of which the jitter value jitter_rms is closest to and less than the maximum clock jitter limit may be finally obtained. According to the calculation, the maximum allowable number of layers, of which the jitter value does not exceed the maximum clock jitter limit, i.e. 500 fs rms, is 18 layers, and at this time, the clock jitter value of the clock architecture is:

$$jitter\_rms = \sqrt{{200}^{2} + ( {100}^{2} + {40}^{2} ) \times 18} = 498.799 fs .$$

It may be understood that the maximum allowable number of layers of the clock architecture herein does not represent the number of all clock modules M in the clock architecture, but refers to the number of clock module layers in the clock architecture and corresponds to the number of clock modules M in the longest communication link; for example, M2 and M2-1 in FIG. 2 are both clock modules in the second clock module layer.

In some optional embodiments, the BMC circuits may also communicate with the host server; refer to FIG. 5, all the BMC circuits are connected to the host server via an I2C bus. In some optional embodiments, the clock architecture further includes a hub HUB; and physical layer interfaces of all the BMC circuits and network ports of the host server are respectively connected to interfaces of the hub. In practical applications, any one of the two connection modes may be selected or both the two connection modes may be selected for implementation, and the BMC circuits in two different clock modules and the host server and the BMC circuits may communicate with each other, thereby implementing dynamic switching of clock signals.

Embodiments of the present disclosure disclose a clock architecture; the selection switch circuit in each clock module may select the local clock signal or the external clock signal as an output clock, such that regulation and control of clock in a processing assembly using the clock architecture, such as a high-speed computing assembly, is more flexible; and the characteristics of the clock architecture being scalable and the clock being selectable provide a reliable basis for improving the accurate operation of the processing assembly.

Correspondingly, embodiments of the present disclosure further disclose a processing assembly, including:
a clock architecture, the clock architecture including one or more clock module layers each clock module layer including one or more clock modules, each clock module including a local clock generator, a selection switch circuit and a plurality of clock buffer circuits; wherein
the local clock generator is configured to generate an independent local clock signal;
a first input terminal of the selection switch circuit receives the local clock signal, a second input terminal of the selection switch circuit receives an external clock signal, a plurality of output terminals of the selection switch circuit are respectively connected to input terminals of the plurality of clock buffer circuits, and an enable terminal of the selection switch circuit is configured to receive an enable signal; and
the selection switch circuit is configured to enable, all the output terminals to output the local clock or enable all the output terminals to output the external clock signal, according to the enable signal,
and a host server, providing an external clock signal for the highest clock module layer in the clock architecture;
wherein each clock signal terminal is respectively connected to a plurality of non-clock modules of the output terminal of the clock buffer circuit in the clock architecture.

Optionally, the clock architecture in the processing assembly includes one or more clock module layers; wherein each clock module layer includes one or more clock modules M. Refer to FIG. 1, each clock module M includes a local clock generator clk gen, a selection switch circuit MUX, and a plurality of clock buffer circuits clk buffer, wherein
the local clock generator clk gen is configured to generate an independent local clock signal clk_m;
a first input terminal of the selection switch circuit MUX receives the local clock signal clk_m, a second input terminal of the selection switch circuit receives an external clock signal clk_h, a plurality of output terminals of the selection switch circuit MUX are respectively connected to input terminals of the plurality of clock buffer circuits clk buffer, and an enable terminal of the selection switch circuit MUX is configured to receive an enable signal; and
the selection switch circuit MUX is configured to enable, all the output terminals to output the local clock signal clk_m or enable all the output terminals to output the external clock signal clk_h, according to the enable signal.

It may be understood that the external clock signal clk_h of the clock module M in the highest clock module layer is provided by a host server.

It may be understood that an output terminal of each clock buffer circuit clk buffer is connected to a next-stage module one by one, and the next-stage module includes a non-clock module and/or a clock module M at a next clock module layer. Optionally, when the next-stage module is the clock module M at the next clock module layer, the output terminal of the corresponding clock buffer circuit clk buffer is connected to the second input terminal of the clock module M at the next clock module layer.

Optionally, the clock module M at each layer further includes: a BMC circuit, configured to be connected to the enable terminal of the selection switch circuit MUX and generate the enable signal. It may be understood that usually, a General Purpose Input/Output (GPIO) terminal of the BMC circuit is connected to the enable terminal SEL pin of the MUX, and sends the enable signal to the enable terminal SEL pin.

It may be understood that the two input terminals of the selection switch circuit MUX receive two different clocks: the local clock signal clk_m and the external clock signal clk_h; according to the characteristics of the selection switch circuit MUX, all the output terminals of the selection switch circuit MUX output the same output clock; and according to a relationship between a level of the enable signal and configuration, all the output terminals of the selection switch circuit MUX may simultaneously output the local clock signal clk_m, or all the output terminals of the selection switch circuit MUX may simultaneously output the external clock signal clk_h. By selecting the output of the selection switch circuit MUX in the current clock module M, a corresponding clock is provided for the next-stage module in the current clock module M, so as to ensure that the next-stage module operates according to the clock.

It may be understood that the non-clock module includes a computing module and/or a communication module and/or a storage module, and each computing module is respectively connected to one output terminal of the clock buffer circuit clk buffer.

It may be understood that setting of the non-clock module may be adjusted according to the type of a processing assembly to which the clock architecture is applied. Hereinafter, description is made by taking the processing assembly being a high-speed computing assembly as an example:

In some optional embodiments, the computing module includes an FPGA circuit, and/or a CPLD circuit, and/or a GPU circuit; the computing module further includes a storage circuit, the storage circuit being connected to the FPGA circuit or the CPLD circuit or the GPU circuit. It may be understood that generally, the storage circuit and the FPGA circuit may form one computing unit, i.e. a Computing Module, and a plurality of computing units may form one high-speed computing assembly; clocks of all the units in the high-speed computing assembly are correspondingly provided by the clock architecture in the present embodiment. As the clock supply of the clock architecture in the present embodiment is flexible and the architecture is scalable, clock support may be provided for computing modules with higher computing power. The type of the computing module depends on the internal structure of the high-speed computing module to be served by the clock architecture.

Optionally, the storage circuit includes a memory bank and a storage hard disk, wherein the memory bank may be selected as Dual Inline Memory Modules (DIMMs), and the storage hard disk may be selected from an SSD or other forms of storage hard disks. Similarly, the type of storage circuit depends on the internal structure of the high-speed computing module to be served by the clock architecture.

Optionally, the communication module includes: a communication unit and/or a communication card slot, and a clock terminal of the communication module is independently connected to one output terminal of the clock buffer circuit clk buffer. It may be understood that the communication unit and the communication card slot may be determined according to a communication protocol; a PCIe protocol is usually selected. Correspondingly, the communication unit includes but is not limited to a PCIe switch and the communication card slot includes a PCIe slot.

Taking the single-layer clock module M shown in FIG. 1 as an example, the clock module M includes four clock buffer circuits: a first clock buffer circuit clk buffer 1, a second clock buffer circuit clk buffer 2, a third clock buffer circuit clk buffer 3, and a fourth clock buffer circuit clk buffer 4; output terminals of all the clock buffer circuits clk buffer provide the same clock, and the number of output terminals on each clock buffer circuit clk buffer and the number of channels provided by each output terminal may be determined according to the internal structure of the high-speed computing module to be served by the clock architecture.

Optionally, in FIG. 1, the first clock buffer circuit clk buffer 1 provides five output terminals; wherein a first output terminal clk_<0:3> is connected to a communication card slot PCIe slot*4, and provides a clock for a host; a second output terminal clk<4:7> is connected to a communication card slot PCIe slot*4, and provides a clock for scale-up; a third output terminal clk<8:11> is connected to a communication card slot PCIe slot*4, and provides a clock for scale-out; a fourth output terminal clk_<12:15> is connected to a computing module FPGA 1, and the FPGA 1 is further connected to a memory bank DIMM, and the two form a computing unit, i.e. Computing Module 1; and a fifth output terminal clk_<16:19> is connected to a computing module FPGA 3, and the FPGA 3 is also connected to another memory bank DIMM, and the two form a computing unit, i.e. Computing Module 3.

Similarly, in FIG. 1, the second clock buffer circuit clk buffer 2 provides three output terminals; wherein a first output terminal clk_<0:7> is connected to an 8-channel storage hard disk of an NVME protocol, i.e. NVME SSD*8 (denoted as SW #1); a second output terminal clk_<8:15> is connected to another 8-channel storage hard disk of an NVME protocol, i.e. NVME SSD*8 (denoted as SW #2); and a third output terminal clk_<16:19> is connected to a computing module FPGA 2, and the FPGA 2 is also connected to a memory bank DIMM, and the two form a computing unit, i.e. Computing Module 2.

Similarly, in FIG. 1, the third clock buffer circuit clk buffer 3 provides three output terminals; wherein a first output terminal clk_<0:7> is connected to an 8-channel storage hard disk of an NVME protocol, i.e. NVME SSD*8 (denoted as SW #3); a second output terminal clk<8:15> is connected to another 8-channel storage hard disk of an NVME protocol, i.e. NVME SSD*8 (denoted as SW #4); and a third output terminal clk_<16:19> is connected to a computing module FPGA 4, and the FPGA 4 is also connected to a memory bank DIMM, and the two form a computing unit, i.e. Computing Module 4.

Similarly, in FIG. 1, the fourth clock buffer circuit clk buffer 4 provides seven output terminals; wherein a first output terminal to a sixth output terminal 100M<0>, 100M<1>, 100M<2>, 100M<3>, 100M<4>, 100M<5> are respectively connected to communication units: PCIe switch #1-PCIe switch #5, and a seventh output terminal 100M<6> is connected to a BMC circuit; the BMC circuit herein refers to a BMC circuit which is configured to output the enable signal in the current clock module M. Hence, the output terminal of the clock buffer circuit clk buffer may also be connected to the BMC circuit, thereby providing clock support for the BMC circuit.

It may be understood that the next-stage module of each clock module M is in a form of a non-clock module, which may be determined according to the internal structure of the high-speed computing module to be served by the clock architecture; and when the next-stage module of the clock module M is a clock module M at a next clock module layer, adjacent clock modules M are connected in series. Optionally, each clock module M has an independent local clock signal clk_m generated by an internal local clock generator clk gen and an external clock signal clk_h; the external clock signal clk_h of the clock module M in the highest clock module layer is provided by the host server, and the external clock signals clk_h of the clock modules M of other clock module layers are provided by the clock modules M of previous layers; one output terminal of the selection switch circuit MUX in the clock module M of the previous layer is connected to an input terminal of one clock buffer circuit clk buffer, and an output terminal of the clock buffer circuit clk buffer is connected to a second input terminal of the clock module M of another clock module layer, and sends the external clock signal clk_h to the clock module M of the another clock module layer.

It may be understood that when the next-stage module is the clock module M at the next clock module layer, the output terminal of the corresponding clock buffer circuit clk buffer is connected to the second input terminal of the clock module M at the next clock module layer via one communication card slot.

As shown in FIG. 2, FIG. 2 is an example of an optional clock architecture. In the clock architecture, the content that the next-stage module is a non-clock module is ignored, and this clock architecture is only directed to a connection structure of the clock modules M in multiple clock module layers; wherein M1 is a clock module at a highest clock module layer, an external clock signal thereof is provided by the host server, and M1 provides the external clock signal for clock modules M2, M2-1, M2-2 and M2-3 at a second clock module layer respectively via a plurality of communication card slots PCIe slots; and the clock modules at the second clock module layer provide the external clock signal for next-layer clock modules respectively connected thereto. For each clock module, there are two optional clocks, i.e. the external clock signal clk_h and the local clock signal clk_m, and inside the clock module M, from the two optional clocks, a clock may be determined as a clock of the non-clock module and a clock may be determined as an external clock signal of the clock module M at a next clock module layer via the selection switch MUX.

It may be understood that PCIe connection is configured to transfer large amounts of data from a transmitter to the receiver, and ensures a high success rate of data transmission. In order to achieve this, the data transferred by the transmitter in a bit center or adjacent bits must be sampled by the receiver, and a frequency/frequency data recovery (Clock/Data Recovery block, CDR) in the receiver will generate a frequency, and the data is periodically sampled to a latch. In this process, various phase jitter sources cause a fluctuation of a sample time sequence. As the sample position deviates from an ideal position, the Bit Error rate increases, thereby causing a correctable error or an uncorrectable error when PCIe is in operation.

Correspondingly, in this embodiment, clocks in the clock architecture are optional, and not only a common clock architecture may be selected to be supported to provide clocks for the high-speed computing assembly, but also a separate clock architecture may be selected to be supported to provide clocks for the high-speed computing assembly. The clock architecture supports automatic switching between the two clock architectures, and also supports a spread spectrum frequency (SSC) and clock jitter budget control.

Optionally, a maximum allowable number of layers of clock module layers in the clock architecture is determined by the maximum clock jitter limit. Generally, the maximum clock jitter limit is determined according to a communication protocol used, and different clock jitter limits may be specified for different PCIe protocols by using a PCI sig protocol, as shown in Table 1.

Optionally, in the clock architecture, the calculation of the clock jitter uses element jitter as a calculation parameter, and the jitter value of the clock link with the longest communication path serves as the clock jitter value of the current clock architecture. Optionally, the process that the maximum allowable number of layers of clock module layers is determined by the maximum clock jitter limit is as shown in FIG. 4 and includes:
S1: a topological relationship of a current clock architecture is acquired;
S2: a clock link with the longest communication path in the topological relationship is determined;
S3: a jitter value of the clock link is calculated according to a jitter value of each element of the current clock architecture; and
S4: the maximum allowable number of layers in the clock architecture is determined according to the jitter value and the maximum clock jitter limit.

In some optional embodiments, the process that the maximum allowable number of layers in the clock architecture is determined according to the jitter value and the maximum clock jitter limit, includes:
the magnitude of the jitter value is compared with that of the maximum clock jitter limit;
the number of layers of clock module layers in the current clock architecture is adjusted, and return to execute the operation that the topological relationship of the current clock architecture is acquired; and
when the jitter value corresponding to N clock module layers exceeds the maximum clock jitter limit and the jitter value corresponding to N−1 clock module layers does not exceed the maximum clock jitter limit, it is determined that the maximum allowable number of layers in the clock architecture is N−1; where N is an integer not less than 1.

In some optional embodiments, the process that the jitter value of the clock link is calculated according to the jitter value of each element of the current clock architecture, includes:
square root calculation is performed on a sum of squares of the jitter values of various elements on the clock link to obtain the jitter value of the clock link.

Optionally, taking FIG. 1 as an example, the model of the local clock generator clk gen may be selected as a 9SQ440 from the company IDT, and the 9SQ440 may generate a stable clock source output of 100 MHz through an external quartz crystal oscillator of 25 MHz; the model of the selection switch circuit MUX may be selected as a 9DML04 from the company IDT, and the 9DML04 has two 100 MHz clock input terminals and has four stable 100 MHz output terminals; the model of the BMC circuit may be selected as AST2600 from ASPEED company, and the model of the clock buffer circuit clk buffer may be selected as 9QXL2001BNHGI; and the BMC circuit is connected to an enable pin SEL pin of the selection switch circuit MUX via a GPIO terminal, so as to achieve the function of automatically switching an input port. Optionally, when the GPIO terminal outputs a low-level enable signal, the selection switch circuit MUX switches a clock input port to the external clock signal clk_h; and when the GPIO terminal outputs a high-level enable signal, the selection switch circuit MUX switches the clock input port to the local clock signal clk_m. The enable control logic may also be adjusted according to actual needs, which is not limited herein.

Taking FIG. 1 as an example, according to the model-selected maximum clock jitter parameter, the element jitter of the external clock signal clk_h provided by the host server is 200 fs, the element jitter of the selection switch circuit MUX is 100 fs, the element jitter of the clock buffer circuit clk buffer is 40 fs, and the clock jitter value of the current clock module M is jitter_rmx=\sqrt{200²+100²+40²}=227.2 fs, and the maximum clock jitter limit of the current clock architecture is 500 fs rms, and apparently, the clock jitter value of the current clock module M is less than the maximum clock jitter limit.

Optionally, the selected model in FIG. 1 is applied to the clock architecture in FIG. 2. Taking the number of the clock module layers n=3, that is, the clock link with the longest communication path being 3 as an example, the clock jitter value of the clock architecture in FIG. 2 is:

$$jitter\_rms = \sqrt{{200}^{2} + {100}^{2} + {40}^{2} + {100}^{2} + {40}^{2} + {100}^{2} + {40}^{2}} = 273.5 fs ;$$

the maximum clock jitter limit is still 500 fs rms, and thus the clock jitter value of three clock module layers meets the requirement of clock jitter.

Optionally, for applying the selected model in FIG. 1 to the clock architecture of FIG. 2, suppose that the element jitter of the external clock signal clk_h provided by the host server is 200 fs, the element jitter of the selection switch circuit MUX in each clock module M is 100 fs, and the element jitter of the clock buffer circuit clk buffer is 40 fs, then the clock link with the longest communication path corresponding to N clock module layers includes N clock modules M connected in series; in this case, the jitter value of the clock link is calculated as: jitter_rms={square root over (200²+(100²+40²>× N)}. By taking the values of N one by one and calculating the jitter value, the maximum allowable number of layers of which the jitter value jitter_rms is closest to and less than the maximum clock jitter limit may be finally obtained. According to the calculation, the maximum allowable number of layers, of which the jitter value does not exceed the maximum clock jitter limit, i.e. 500 fs rms, is 18 layers, and at this time, the clock jitter value of the clock architecture is:

$$jitter\_rms = \sqrt{{200}^{2} + ( {100}^{2} + {40}^{2} ) \times 18} = 498.799 fs .$$

It may be understood that the maximum allowable number of layers of the clock architecture herein does not represent the number of all clock modules M in the clock architecture, but refers to the number of clock module layers in the clock architecture and corresponds to the number of clock modules M in the longest communication link; for example, M2 and M2-1 in FIG. 2 are both clock modules in the second clock module layer.

In some optional embodiments, the BMC circuits may also communicate with the host server; refer to FIG. 5, all the BMC circuits are connected to the host server via an I2C bus. In some optional embodiments, the clock architecture further includes a hub HUB; and physical layer interfaces of all the BMC circuits and network ports of the host server are respectively connected to interfaces of the hub. In practical applications, any one of the two connection modes may be selected or both the two connection modes may be selected for implementation, and the BMC circuits in two different clock modules and the host server and the BMC circuits may communicate with each other, thereby implementing dynamic switching of clock signals.

In the clock architecture of embodiments of the present disclosure, the selection switch circuit in each clock module may select the local clock signal or the external clock signal as an output clock, such that regulation and control of clock in a processing assembly using the clock architecture, such as a high-speed computing assembly, is more flexible; and the characteristics of the clock architecture being scalable and the clock being selectable provide a reliable basis for improving the accurate operation of the processing assembly.

Finally, it should also be noted that in the present text, relational terms such as first and second, etc. are only used to distinguish one entity or operation from another entity or operation, and do not necessarily require or imply any actual relationship or sequence between these entities or operations. Furthermore, the terms “include”, “including”, or any other variations thereof are intended to cover a non-exclusive inclusion, so that a process, a method, an article, or a device that includes a series of elements not only includes those elements, but also includes other elements that are not explicitly listed, or further includes inherent elements of the process, the method, the article, or the device. Without further limitation, an element defined by a sentence “including a . . . ” does not exclude other same elements existing in the process, the method, the article, or the device that includes the element.

Hereinabove, the clock architecture and the processing assembly provided in the embodiments of the present disclosure have been described in detail. The principle of embodiments of the present disclosure and the embodiments have been described herein by applying optional examples, and the illustration of the embodiments above is only used to help understand the method and core ideas of embodiments of the present disclosure; meanwhile, a person of ordinary skill in the art may make modifications to the optional embodiments and application ranges according to the idea of embodiments of the present disclosure. In conclusion, the content of the present description shall not be construed as limitation to the embodiments of the present disclosure.

1. A clock architecture, the clock architecture comprising one or more clock module layers; each clock module layer comprising one or more clock modules, each clock module comprising a local clock generator, a selection switch circuit and a plurality of clock buffer circuits; wherein
the local clock generator is configured to generate an independent local clock signal;
a first input terminal of the selection switch circuit receives the local clock signal, a second input terminal of the selection switch circuit receives an external clock signal, a plurality of output terminals of the selection switch circuit are respectively connected to input terminals of the plurality of clock buffer circuits, and an enable terminal of the selection switch circuit is configured to receive an enable signal; and
the selection switch circuit is configured to enable, all the output terminals to output the local clock or enable all the output terminals to output the external clock signal, according to the enable signal.

2. The clock architecture according to claim 1, wherein the external clock signal of the clock module in the highest clock module layer is provided by a host server.

3. The clock architecture according to claim 1, wherein an output terminal of each clock buffer circuit is connected to a next-stage module one by one, and the next-stage module comprises a non-clock module and/or the clock module at a next clock module layer.

4. The clock architecture according to claim 3, wherein when the next-stage module is the clock module at the next clock module layer, the output terminal of the corresponding clock buffer circuit is connected to the second input terminal of the clock module at the next clock module layer.

5. The clock architecture according to claim 1, wherein each clock module further comprises:
a Baseboard Management Controller (BMC) circuit, configured to be connected to the enable terminal of the selection switch circuit and generate the enable signal.

6. The clock architecture according to claim 5, wherein the clock architecture further comprises a hub;
and physical layer interfaces of all the BMC circuits and network ports of the host server are respectively connected to interfaces of the hub.

7. The clock architecture according to claim 3, wherein the non-clock module comprises a computing module and/or a communication module and/or a storage module, and each computing module is respectively connected to one output terminal of the clock buffer circuit.

8. The clock architecture according to claim 7, wherein the computing module comprises an Field Programmable Gate Array (FPGA) circuit, and/or a Complex Programmable Logic Device (CPLD) circuit, and/or a Graphics Processing Unit (GPU) circuit;
the computing module further comprises a storage circuit, the storage circuit being connected to the FPGA circuit or the CPLD circuit or the GPU circuit.

9. The clock architecture according to claim 7, wherein the communication module comprises: a communication unit and/or a communication card slot, and a clock terminal of the communication module is independently connected to one output terminal of the clock buffer circuit.

10. The clock architecture according to claim 3, wherein
when the next-stage module is the clock module at the next clock module layer, the output terminal of the corresponding clock buffer circuit is connected to the second input terminal of the clock module at the next clock module layer via one communication card slot

11. The clock architecture according to a claim 1, wherein a maximum allowable number of layers of clock module layers in the clock architecture is determined by the maximum clock jitter limit.

12. The clock architecture according to claim 11, wherein the process of determining the maximum allowable number of layers of clock module layers by the maximum clock jitter limit, comprises:
acquiring a topological relationship of a current clock architecture;
determining a clock link with the longest communication path in the topological relationship;
calculating a jitter value of the clock link according to a jitter value of each element of the current clock architecture; and
determining the maximum allowable number of layers in the clock architecture according to the jitter value and the maximum clock jitter limit.

13. The clock architecture according to claim 12, wherein the process of determining the maximum allowable number of layers in the clock architecture according to the jitter value and the maximum clock jitter limit, comprises:
comparing the magnitude of the jitter value with that of the maximum clock jitter limit;
adjusting the number of layers of clock module layers in the current clock architecture, and returning to execute the operation of acquiring the topological relationship of the current clock architecture; and
when the jitter value corresponding to N clock module layers exceeds the maximum clock jitter limit and the jitter value corresponding to N−1 clock module layers does not exceed the maximum clock jitter limit, determining that the maximum allowable number of layers in the clock architecture is N−1; where N is an integer not less than 1.

14. The clock architecture according to claim 12, wherein the process of calculating the jitter value of the clock link according to the jitter value of each element of the current clock architecture, comprises:
performing square root calculation on a sum of squares of the jitter values of various elements on the clock link to obtain the jitter value of the clock link.

15. The clock architecture according to claim 5, wherein a General Purpose Input/Output (GPIO) terminal of the BMC circuit is connected to the enable terminal of the selection switch circuit, and the GPIO terminal is configured to send the enable signal to the enable terminal.

16. The clock architecture according to claim 1, wherein the process of enabling, all the output terminals to output the local clock signal or enabling all the output terminals to output the external clock signal, according to the enable signal, comprises:
enabling all the output terminals to output the local clock signal simultaneously or enabling all the output terminals to output the external clock signal simultaneously according to a relationship between a level of the enable signal and configuration.

17. The clock architecture according to claim 8, wherein the storage circuit comprises a memory bank and a storage hard disk.

18. The clock architecture according to claim 11, wherein the maximum clock jitter limit is determined according to a communication protocol used.

19. A processing assembly, comprising:
a clock architecture, the clock architecture comprising one or more clock module layers each clock module layer comprising one or more clock modules, each clock module comprising a local clock generator, a selection switch circuit and a plurality of clock buffer circuits; wherein
the local clock generator is configured to generate an independent local clock signal;
a first input terminal of the selection switch circuit receives the local clock signal, a second input terminal of the selection switch circuit receives an external clock signal, a plurality of output terminals of the selection switch circuit are respectively connected to input terminals of the plurality of clock buffer circuits, and an enable terminal of the selection switch circuit is configured to receive an enable signal; and
the selection switch circuit is configured to enable, all the output terminals to output the local clock or enable all the output terminals to output the external clock signal, according to the enable signal,
and
a host server, providing an external clock signal for the highest clock module layer in the clock architecture;
wherein each clock signal terminal is respectively connected to a plurality of non-clock modules of the output terminal of the clock buffer circuit in the clock architecture.

20. The processing assembly according to claim 19, wherein the processing assembly is a high-speed computing module, and clocks of all units in the high-speed computing module are correspondingly provided by the clock architecture.
